(19) United States
(12) Patent Application Publication
(10) Pub. No.: US 2026/0316686 A1
(43) Pub. Date: Oct. 15, 2026

(54) STORAGE BOX AND VEHICLE

(71) Applicant: KAWASAKI MOTORS, LTD., Hyogo (JP)

(72) Inventor: Alexander RICKABAUGH, Lincoln, NE (US)

(73) Assignee: KAWASAKI MOTORS, LTD., Hyogo (JP)

(21) Appl. No.: 19/639,534

(22) Filed: Apr. 6, 2026

Related U.S. Application Data
(60) Provisional application No. 63/786,146, filed on Apr. 9, 2025.

(51) Int. Cl. B60R 9/06; B60Q 1/30; B60Q 3/30; B60R 21/13; B62D 25/04

(52) U.S. Cl. CPC B60R 9/065; B60Q 1/30; B60Q 3/30; B60R 21/13; B62D 25/04

(57) ABSTRACT

A storage box is attached to a cargo bed of a vehicle. The storage box includes a box part including an opening portion and a cover supported on the box part to be angularly displaceable around a rotational axis and closing the opening portion. The cover includes an inner surface facing a side of the box part in a close state and a light attachment portion located in a part of the inner surface.

### CROSS-REFERENCE TO RELATED APPLICATION

The present application claims priority to U.S. Provisional Application No. 63/786,146 filed on Apr. 9, 2025, the content of which is incorporated herein by reference.

### TECHNICAL FIELD

The present disclosure relates to a storage box and a vehicle.

### BACKGROUND ART

U.S. Pat. No. 12,077,130 B2 discloses a technique of providing a cargo area to a rear part of a vehicle and a cover covering the cargo area.

### SUMMARY

A storage box according to the present disclosure is a storage box attached to a cargo bed of a vehicle, including: a box part having an opening portion; and a cover supported on the box part to be angularly displaceable around a rotational axis and closing the opening portion, wherein the cover includes an inner surface facing a side of the box part in a close state and a light attachment portion located in a part of the inner surface.

According to the present disclosure, a light can be attached to the cover by the light attachment portion.

The objects, features, aspects, and advantages of this disclosure will become more apparent from the following detailed description and the accompanying diagrams.

### BRIEF DESCRIPTION OF DRAWINGS

FIG. 1 is a perspective view illustrating a vehicle according to a first embodiment.

FIG. 2 is a perspective view illustrating a rear part of the vehicle.

FIG. 3 is a perspective view illustrating the rear part of the vehicle with no storage box.

FIG. 4 is a plan view illustrating the rear part of the vehicle.

FIG. 5 is a perspective view illustrating the rear part of the vehicle.

FIG. 6 is a diagram explaining a relationship between the storage box and a rear pillar part.

FIG. 7 is a perspective view illustrating a cover of the storage box.

FIG. 8 is a cross-sectional view illustrating the storage box.

FIG. 9 is a cross-sectional view illustrating the storage box.

FIG. 10 is a cross-sectional view illustrating the storage box.

FIG. 11 is a perspective view illustrating a rear part of a vehicle according to a second embodiment.

FIG. 12 is a perspective view illustrating the rear part of the vehicle.

FIG. 13 is a perspective view illustrating the rear part of the vehicle.

FIG. 14 is a perspective view illustrating a storage box.

FIG. 15 is a perspective view illustrating the storage box.

FIG. 16 is a plan view illustrating a cover of the storage box.

FIG. 17 is a perspective view illustrating a storage net.

FIG. 18 is a cross-sectional view illustrating the storage box.

FIG. 19 is a cross-sectional view illustrating the storage box.

### DESCRIPTION OF THE PREFERRED EMBODIMENTS

### First Embodiment

A storage box according to a first embodiment and a vehicle including the storage box will be hereinafter described.

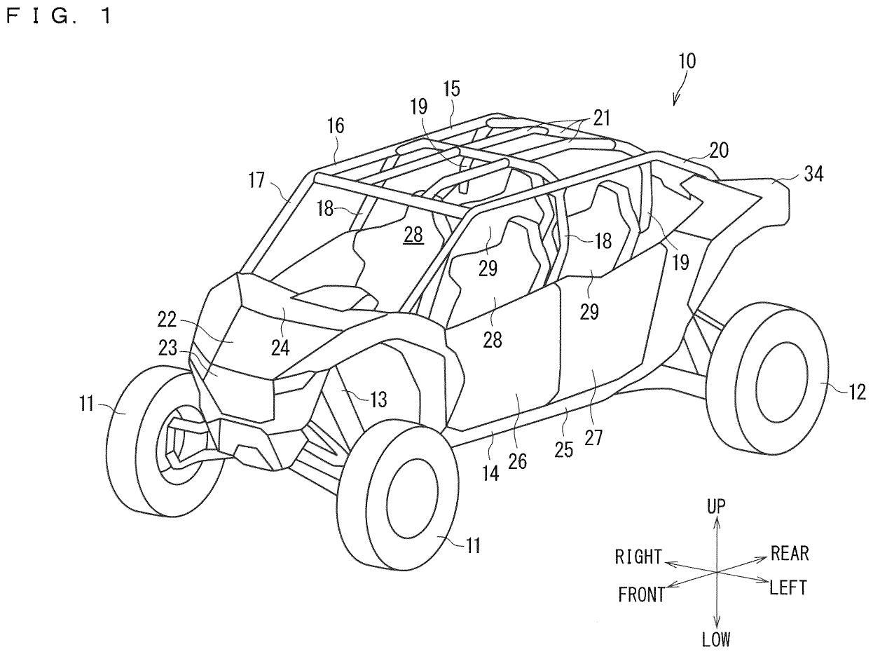

FIG. 1 is a perspective view illustrating a vehicle 10 according to a first embodiment. In the following description, a travel direction of the vehicle 10 may be expressed as FRONT, a direction opposite to the travel direction may be expressed as REAR, a road surface side on which the vehicle 10 travels may be expressed as LOW, and a side opposite to the road surface side may be expressed as UP. A road surface is a ground or a road. RIGHT and LEFT may be referred to while a person stands on a road surface and faces frontward. A right-left direction is a vehicle-width direction.

The vehicle 10 is a wheeled vehicle traveling on the road surface. The vehicle 10 may be an off-road vehicle, for example. The off-road vehicle may be a versatile small vehicle suitable for off-road travel rather than for fast travel on a public road.

Examples of the off-road vehicle include a side-by-side vehicle. The side-by-side vehicle is, for example, a small vehicle suitable for all terrain travel, and a vehicle in which occupants can be seated side by side. The side-by-side vehicle may be, for example, a multipurpose off-highway utility vehicle (MOHUV) defined by ANSI/OPEI B71.9-2016, and a recreational off-highway vehicle defined by ANSI/ROHVA 1-2016.

The vehicle 10 may be a passenger transport vehicle designed to travel at low speeds within a limited area.

Examples of the limited area may include limited community areas, private roads, and private lands (e.g., golf courses and parks). The limited community areas are areas provided for use by community residents. The community areas are, for example, areas including houses and public facilities (e.g., schools and hospitals), and are areas in which the vehicle 10 designed to travel through non-public highways are permitted to travel at low speeds. The low speed is, for example, a speed with an upper limit ranging from 20 mph to 30 mph. The vehicle 10 includes a personal transport vehicle (PTV) in accordance with ANSI/ILTVA Z135 and a golf cart in accordance with ANSI/ILTVA Z130.1. The vehicle 10 includes a personal transportation electric vehicle.

The vehicle 10 includes front wheels 11, rear wheels 12, and a vehicle body 14. The vehicle 10 includes a travel drive apparatus and a steering apparatus not shown in the diagrams.

The vehicle body 14 has a support structure supporting each part of the vehicle 10. The vehicle body 14 includes a vehicle body frame 15, for example. Herein, the vehicle body frame 15 includes a rollover protective structure (ROPS) 16. The ROPS 16 has a structure that roll bars each made up of a metal pipe are connected, for example. The roll bar includes a front pillar part 17, intermediate pillar parts 18 and 19, a rear pillar part 20, and a roof pole part 21. The front pillar part 17 extends upward from a front side of a front seat 28. The intermediate pillar parts 18 and 19 extend upward from a back side of the front seat 28. The rear pillar part 20 extends upward from a position more backward than the intermediate pillar parts 18 and 19. The front pillar part 17, the intermediate pillar parts 18 and 19, and the rear pillar part 20 are provided in a pair on right and left sides. The roof pole part 21 connects the front pillar part 17, the intermediate pillar parts 18 and 19, and the rear pillar part 20. The roof pole part 21 is provided in a lattice form herein. The roof pole part 21 includes a part extending in a front-back direction and a part extending in a vehicle width direction. Herein, the front pillar part 17, a part of the roof pole part 21 extending in a front-back direction, and the rear pillar part 20 constitute one arch-like roll bar. A lower part of the front pillar part 17 and a lower part of the rear pillar part 20 are connected to the other frame of the vehicle body 14, for example.

The vehicle body 14 includes a floor part 25. The floor part 25 is located in a lower part of a space for passengers. The floor part 25 is a part including a surface for supporting feet of a passenger during traveling or for a passenger getting in and out of the vehicle to place feet for movement. The floor part 25 is a plate-like part spreading in a horizontal direction. The vehicle body frame 15 may include a ladder frame constituting the floor part 25. The floor part 25 may be a floor plate or a part in which a ladder frame and a floor plate are combined. The vehicle body 14 may have a monocoque structure.

The front wheels 11 and the rear wheels 12 are rotatably supported on the vehicle body 14. The front wheels 11 and the rear wheels 12 may be supported on the vehicle body 14 via a suspension apparatus 13. For example, two front wheels 11 are rotatably supported on right and left portions in a front part of the floor part 25. One front wheel 11 is also applicable. For example, two rear wheels 12 are rotatably supported on right and left portions in a rear part of the floor part 25.

The vehicle body 14 may include a panel-like member. A hood 22, a front cover 23, or a dashboard panel 24, for example, may be provided as well as the floor plate as the panel-like member. The dashboard panel 24 is located in front of a driver seat. The hood 22 is located in front of the dashboard panel 24. The front cover 23 is located in a lower part of a front end of the hood 22.

The vehicle 10 includes seats. The vehicle 10 includes a front seat 28 and a rear seat 29 herein. It is also applicable that the vehicle 10 does not include the rear seat 29 but includes only the front seat 28. The floor part 25 is located below the front seat 28 and the rear seat 29. The front seat 28 and the rear seat 29 are supported by the floor part 25. The front seat 28 is located above the floor part 25 and more backward than the dashboard panel 24. The front seat 28 is located more frontward than the rear seat 29. The front seat 28 includes the driver seat.

The vehicle body 14 includes doors 26 and 27 herein. The door 26 is located in a lateral side of the front seat 28. A passenger of the front seat 28 opens and closes the door 26 when getting in and out of the vehicle 10. The door 27 is located in a lateral side of the rear seat 29. A passenger of the rear seat 29 opens and closes the door 27 when getting in and out of the vehicle 10. The vehicle 10 may be a vehicle in which at least two passengers can ride side by side.

The vehicle 10 may be opened outside of the seats in a vehicle width direction without being obstructed by walls or the doors 26 and 27 to facilitate the passengers getting in and out of the vehicle 10. In this case, the passenger can walk past in a right-left direction without being obstructed by the doors 26 and 27 or the walls.

The travel drive apparatus is an apparatus for making the vehicle 10 travel. The travel drive apparatus is supported on the vehicle body 14. The travel drive apparatus includes a motor, for example. The motor may be an electrical motor or an internal combustion engine. For example, a rotation shaft of the motor is connected to a shaft of a drive wheel directly or via a gear. When rotation drive force of the motor is transmitted to the drive wheel, the vehicle 10 can travel. The motor may be located between two rear wheels 12, for example.

The steering apparatus is an apparatus for controlling a travel operation of the vehicle 10. The travel operation is traveling, stopping, a speed, and a travel direction of the vehicle 10, for example.

The steering apparatus includes a steering wheel located more backward than the front wheel 11, for example. The steering wheel is rotatably supported by a steering shaft. The steering wheel is located closer to a front side on the floor part 25. The steering wheel is located more frontward than the front seat 28. The steering shaft is connected to the front wheel 11 via a steering gear, for example. The front wheel 11 is rotated around a steering shaft by an operation of the steering wheel. The travel direction of the vehicle 10 is changed by rotation of the front wheel 11 around the steering shaft.

The dashboard panel 24 is located more frontward than the steering wheel. Meters displaying a speed meter and a battery remaining amount, for example, may be disposed in the dashboard panel 24. An operation pedal may be disposed in a position on the lower side than the steering wheel. The operation pedal may be one pedal capable of controlling start, acceleration, deceleration, and stop by adjusting a degree of pressing the pedal, for example. The operation pedal may be a brake pedal and an acceleration pedal.

The driver seat is located in back of the steering wheel. A driver can be seated on the driver seat to operate the steering wheel and the operation pedal. The vehicle 10 may be a remotely-operated vehicle or an autonomously-traveling vehicle. In this case, the steering wheel and the operation pedal may be omitted.

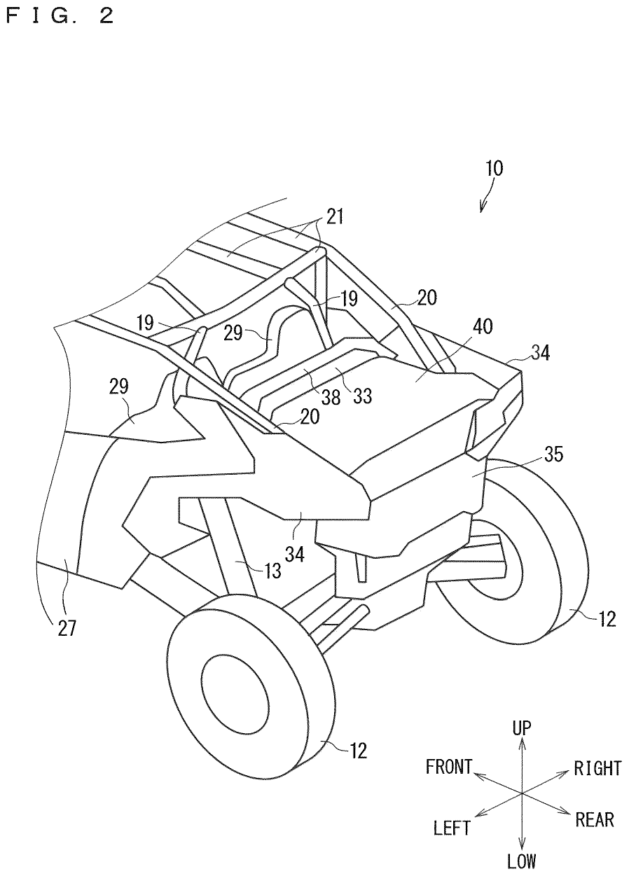

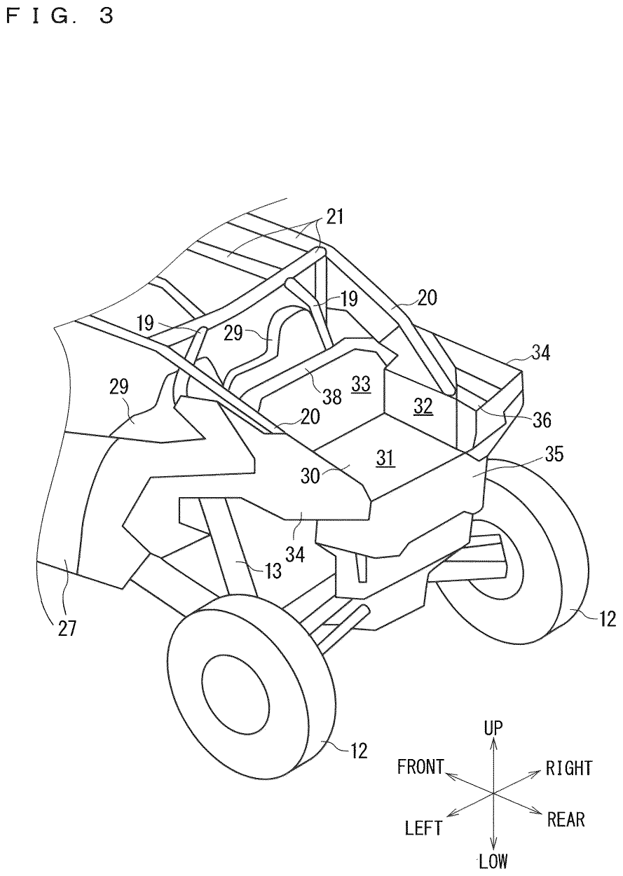

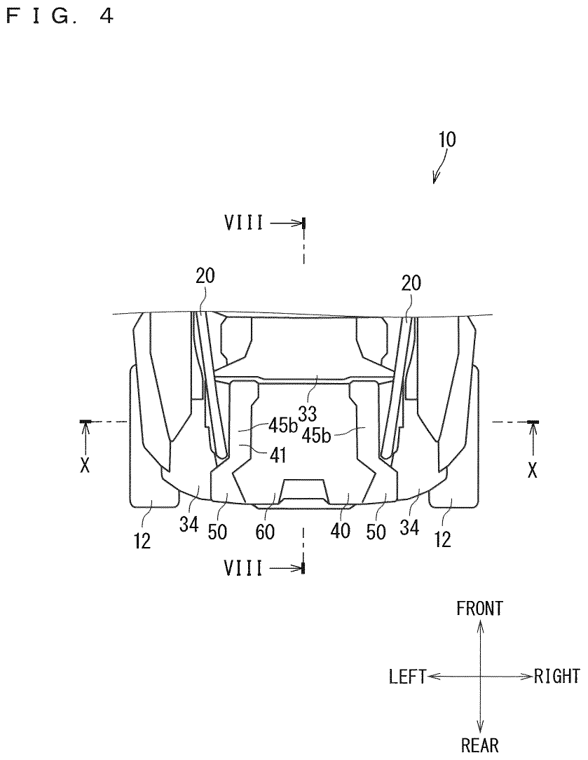

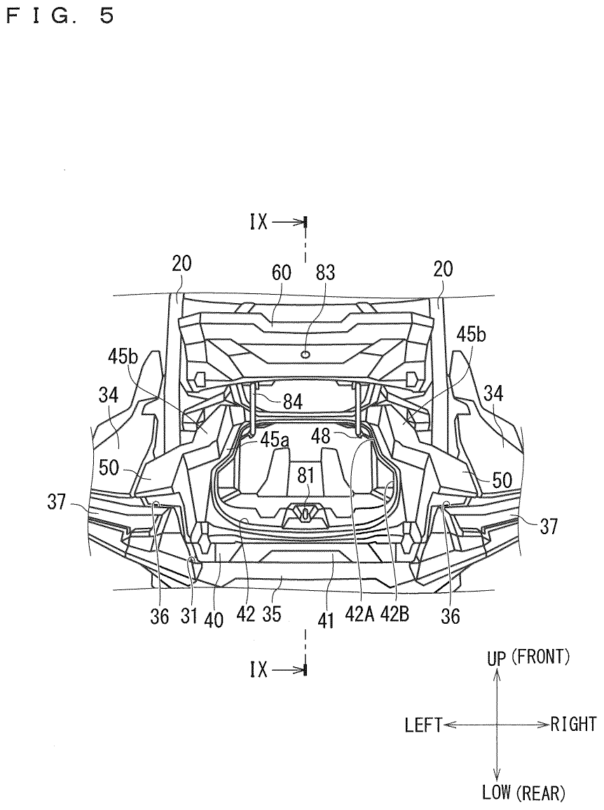

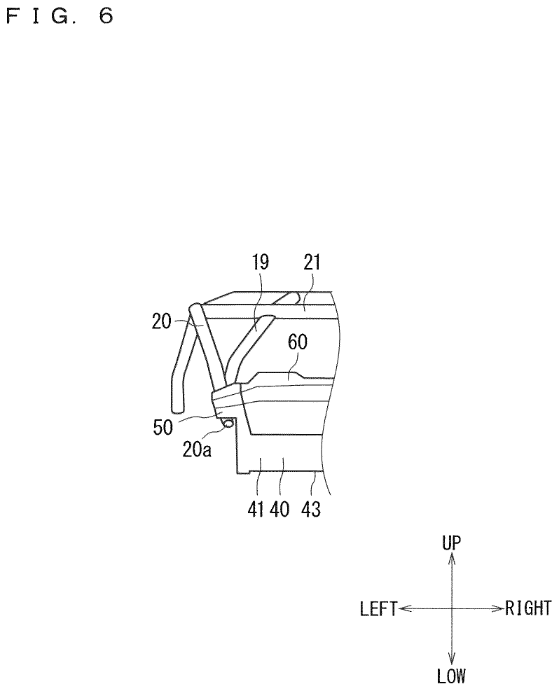

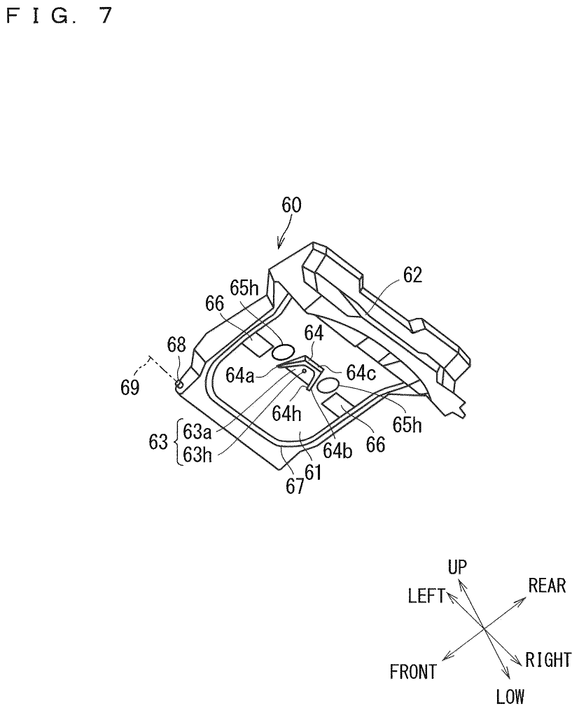

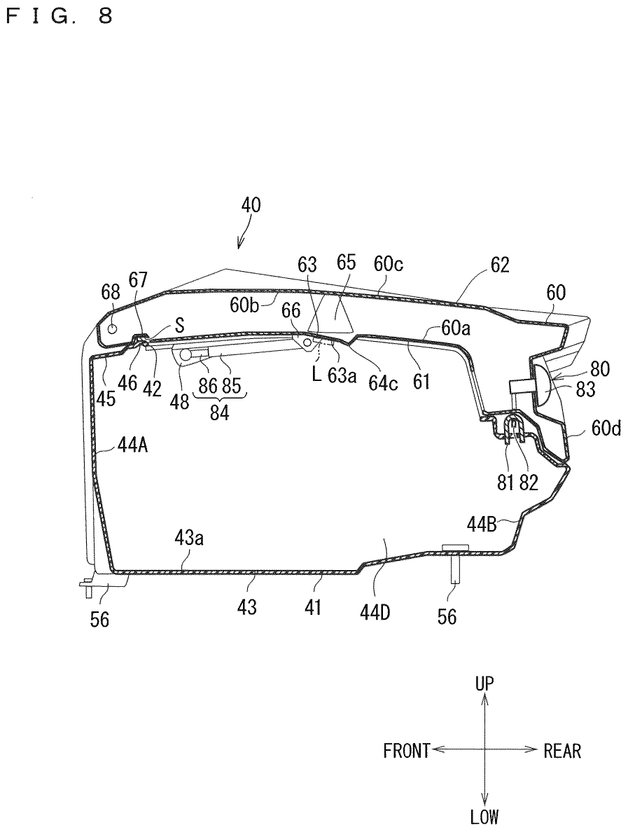

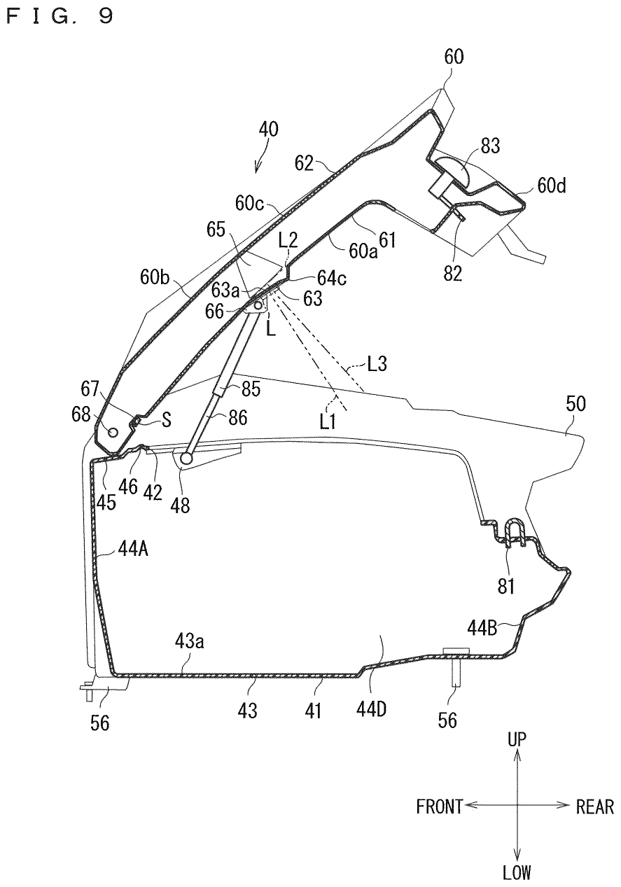

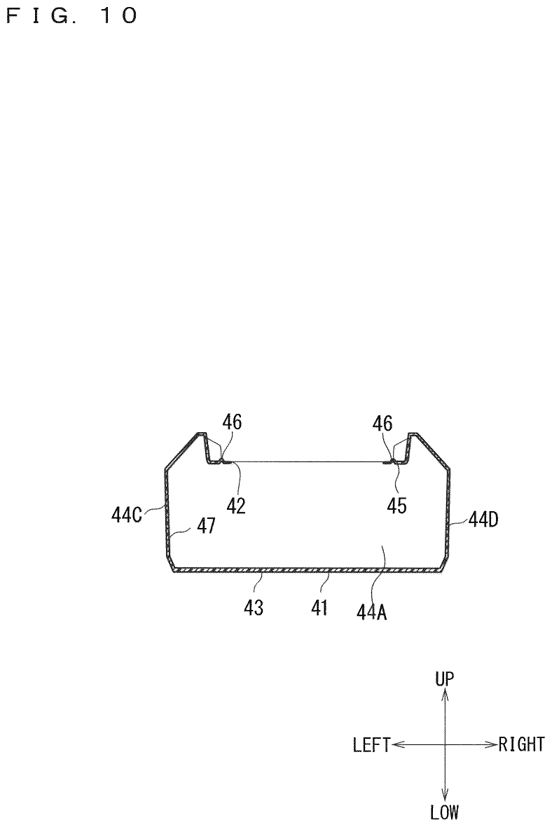

A structure of the rear part of the vehicle 10 is described further with reference to FIG. 2 to FIG. 6. FIG. 2 is a perspective view illustrating the rear part of the vehicle 10. FIG. 3 is a perspective view illustrating the rear part of the vehicle 10 with no storage box 40. FIG. 4 is a plan view illustrating the rear part of the vehicle 10. FIG. 5 is a perspective view illustrating the rear part of the vehicle 10. FIG. 6 is a diagram explaining a relationship between the storage box 40 and the rear pillar part 20. FIG. 7 is a perspective view illustrating a cover 60 of the storage box 40. FIG. 8 is a cross-sectional view illustrating the storage box 40. FIG. 9 is a cross-sectional view illustrating the storage box 40. FIG. 10 is a cross-sectional view illustrating the storage box 40.

The vehicle body 14 includes a cargo bed 30. The vehicle 10 includes the storage box 40 attached to the cargo bed 30. The cargo bed 30 and the storage box 40 are located in the rear part of the vehicle 10.

The seat is located more frontward than the cargo bed 30. The cargo bed 30 is located in back of the rear seat 29. The cargo bed 30 includes a mounting surface 31 on which the storage box 40 is positioned. When there is no storage box 40, luggage can be stored on the mounting surface 31 of the cargo bed 30. A lateral partition wall 32 is located in both lateral sides of the mounting surface 31. A front partition wall 33 is located in front of the mounting surface 31. The lateral partition wall 32 and the front partition wall 33 protrude above the mounting surface 31. The front partition wall 33 and the pair of lateral partition walls 32 partition a front side and both lateral sides of the mounting surface 31.

The vehicle body 14 includes a rear side cover 34, a tail cover 35, and a partition wall 38 herein. The rear side cover 34, the tail cover 35, and the partition wall 38 are located in the rear part of the vehicle 10. The rear side cover 34 is located in a lateral side of the cargo bed 30. The rear side cover 34 is provided to each of right and left sides of the vehicle 10. The tail cover 35 is located below the rear part of the cargo bed 30. The partition wall 38 is located in front of the cargo bed 30. The partition wall 38 is located between the rear seat 29 and the cargo bed 30. A part of the rear side cover 34 including a surface facing an inner side in the vehicle width direction serves as the lateral partition wall 32. A part of the partition wall 38 including a surface facing the back side serves as the front partition wall 33.

For example, a lower part of the intermediate pillar part 19 is connected to the rear part of the rear seat 29. The front partition wall 33 may partition the mounting surface 31 and the lower part of the intermediate pillar part 19. For example, the lower part of the rear pillar part 20 is connected to the lateral side of the cargo bed 30. The lateral partition wall 32 may partition the mounting surface 31 and the lower part of the rear pillar part 20.

As illustrated in FIG. 3, there is an opening between back ends of the pair of rear side covers 34 in the cargo bed 30 with no storage box 40. It is possible to have access to the cargo bed 30 from the opening.

The storage box 40 is attached to the cargo bed 30 of the vehicle 10. The storage box 40 includes a box part 41, the cover 60, and a pair of upper lateral portions 50. The cover 60 is opened and closed with respect to the box part 41. In the present disclosure, a state where the cover 60 is opened is an open state, and a state where the cover 60 is closed is a close state.

The box part 41 includes an opening portion 42. The box part 41 includes a bottom portion 43, a front wall 44A, a rear wall 44B, a left wall 44C, a right wall 44D, and an upper wall 45. A space surrounded by the front wall 44A, the rear wall 44B, the left wall 44C, the right wall 44D, and the upper wall 45 is the housing space of the storage box 40. The opening portion 42 is a hole formed in the box part 41 made by opening a portion of a wall surface of the box part 41 to have access to the housing space.

The bottom portion 43 is disposed on the mounting surface 31 of the cargo bed 30. The front wall 44A protrudes upward from a front edge of the bottom portion 43. The rear wall 44B protrudes upward from a rear edge of the bottom portion 43. The left wall 44C protrudes upward from a left edge of the bottom portion 43. The right wall 44D protrudes upward from a right edge of the bottom portion 43. The upper wall 45 is located on a side opposite to the bottom portion 43. The upper wall 45 connects an upper end of the front wall 44A, an upper end of the rear wall 44B, an upper end of the left wall 44C, and an upper end of the right wall 44D. In the present embodiment, the opening portion 42 is located in the upper wall 45.

The opening portion 42 is located in a center portion 45a of the upper wall 45 along the vehicle width direction. The center portion 45a of the upper wall 45 in which the opening portion 42 is located, is on a lower side than the outer side portion 45b of the upper wall 45 along the vehicle width direction. The cover 60 is housed between the pair of outer side portions 45b in the upper wall 45.

The opening portion 42 of the box part 41 includes a first opening region 42A and a second opening region 42B. The first opening region 42A is a region located on the side of the rotational axis 69 in the opening portion 42 along a front-back direction. The second opening region 42B is a region located on a side opposite to the rotational axis 69 in the opening portion 42 along the front-back direction. As illustrated in FIG. 5, the second opening region 42B has a larger dimension in the vehicle width direction than the first opening region 42A.

The box part 41 includes a bottom surface 43a and an intermediate part located between the bottom surface 43a and the opening portion 42. An upper surface of the bottom portion 43 is the bottom surface 43a. The intermediate part includes a large housing portion 47 having a larger area than the opening portion 42 in a case where the bottom surface 43a is seen from above. In a cross sectional view illustrated in FIG. 10, a part between the bottom portion 43 and the opening portion 42 is wholly the large housing portion 47. A part other than the large housing portion 47 may be located between the bottom portion 43 and the opening portion 42.

The pair of upper lateral portions 50 are located on the right and left sides of the box part 41. The pair of upper lateral portions 50 are larger than the bottom portion 43 of the box part 41 in the vehicle width direction. The pair of upper lateral portions 50 are located on the vehicle body 14 at a position higher than the bottom portion 43 of the box part 41.

The upper lateral portion 50 is located on a back side of the box part 41 along the front-back direction. Herein, the outer side portion 45b on the left side of the upper wall 45 is elongated to protrude to the left side in the rear portion of the box part 41, and the upper lateral portion 50 on the left side is provided herein. In the similar manner, the outer side portion 45b on the right side of the upper wall 45 is elongated to protrude to the right side in the rear portion of the box part 41, and the upper lateral portion 50 on the right side is provided. A space continuing into the housing space of the box part 41 is formed inside the upper lateral portion 50. A space continuing into the housing space of the box part 41 may not be formed inside the upper lateral portion 50.

The upper lateral portion 50 is not provided to a front side of the box part 41 along the front-back direction. The rear edge of the upper lateral portion 50 is located more backward than the opening portion 42.

The cover 60 is supported on the box part 41 to be angularly displaceable around the rotational axis 69 and closes the opening portion 42. The cover 60 includes a shaft portion 68. The shaft portion 68 protrudes outside from a lateral surface of the cover 60 in the vehicle width direction. The box part 41 includes a shaft bearing rotatable supporting the shaft portion 68. A section of the shaft bearing into which the shaft portion 68 is inserted serves as the rotational axis 69. The rotational axis 69 extends along the vehicle-width direction.

The cover 60 is made to be opened to an upward direction from the close state. The shaft portion 68 is located in front of the cover 60. The shaft portion 68 is located more frontward than the opening portion 42. The shaft bearing is located in a wall surface as a level difference between the center portion 45a and the outer side portion 45b in a front side portion of the upper wall 45. When the cover 60 is opened, a back end of the cover 60 is moved upward.

The cover 60 includes an inner surface 61 and an outer surface 62. The inner surface 61 faces a side of the box part 41 in the close state. Herein, the inner surface 61 faces the bottom portion 43 in the closed state. The outer surface 62 faces a side opposite to the inner surface 61. Herein, the cover 60 has a double structure of an inner cover portion 60a and an outer cover portion 60b. The inner cover portion 60a is located closer to the side of the box part 41 in relation to the outer cover portion 60b. One main surface of the inner cover portion 60a constitutes the inner surface 61, and one main surface of the outer cover portion 60b constitutes the outer surface 62. The other main surface of the inner cover portion 60a and the other main surface of the outer cover portion 60b face each other. The upper lateral portion 50 is located on both sides of the inner surface 61 of the cover 60.

A cover support portion 65 supporting the outer cover portion 60b is a feature of the inner cover portion 60a. The cover support portion 65 has a cone-like shape. The cover support portion 65 is a part of the inner cover portion 60a protruding toward the outer cover portion 60b. A cover support opening 65h is formed in the inner surface 61.

The cover 60 includes an upper side portion 60c located above the opening portion 42 in the closed state and a back side portion 60d located in back of the opening portion 42 herein. The back side portion 60d protrudes downward from the back end on an upper side. The back side portion 60d is located on a lower side than the shaft portion 68 in the closed state. The back side portion 60d is located on the upper side of the shaft portion 68 in the open state.

The cover 60 includes a light attachment portion 63. The light attachment portion 63 is located in an area of the inner surface 61. The light attachment portion 63 is an area for attaching a light L. The light attachment portion 63 is located in the inner cover portion 60a. The light attachment portion 63 is located in an intermediate part of the inner cover portion 60a in the front-back direction. The light attachment portion 63 is located in an intermediate part of the inner cover portion 60a in the vehicle width direction.

The light L attached to the light attachment portion 63 is not particularly limited, but may be a light emitting diode (LED), for example. A power source of the light L may be an in-vehicle power source. The light L may include a wiring to be connected to the in-vehicle power source. The power source of the light L may be a power source different from the in-vehicle power source. The light L may include a battery as a power source. The battery may be a replaceable battery.

The light attachment portion 63 includes an inclined surface 63a. The inclined surface 63a is inclined to the side of the box part 41 as getting away from the rotational axis 69 with respect to the inner surface 61 of the cover 60. Herein, the inclined surface 63a is inclined to the bottom portion 43 as getting away from the rotational axis 69 with respect to the inner surface 61. The light attachment portion 63 includes an attachment hole 63h herein. The light attachment portion 63 is an area for attaching the light L. The attachment hole 63h is located in the inclined surface 63a. Since the light L is attached to the inclined surface 63a, light from the light L can be easily directed to the opening portion 42 in the open state.

Specifically, the line L1 in FIG. 9 is a virtual line along the normal direction to the inclined surface 63a. The line L2 is a virtual line showing the inner surface 61 in a case where there is no inclined surface 63a. The line L3 is a virtual line along the normal direction to the virtual inner surface 61. In a paper sheet of FIG. 9. the virtual line L3 is perpendicular to the virtual line L2. When the light L is attached to the inclined surface 63a, a light axis of the light L extends along the virtual line L1. When the light L is attached to the virtual inner surface 61 along the virtual line L2 instead of the inclined surface 63a, the light axis of the light L extends along the virtual line L3. As illustrated in FIG. 9, the virtual line L1 extends more frontward than the virtual line L3. Thus, the light L attached to the inclined surface 63a easily illuminates the opening portion 42.

The cover 60 includes a rib 64. The rib 64 is located around the light attachment portion 63 in the inner surface 61. The rib 64 protrudes closer to the side of the box part 41 in relation to the light attachment portion 63. The rib 64 includes a rib-side opening portion 64h in a side where the rotational axis 69 is located.

The rib 64 includes a pair of sidewall portions 64a and 64b and a connection wall portion 64c. The pair of sidewall portions 64a and 64b extend on both sides of the light attachment portion 63. The connection wall portion 64c connects the pair of sidewall portions 64a and 64b at an opposite side of the rotational axis 69 from the light attachment portion 63. The rib-side opening portion 64h is located between the pair of sidewall portions 64a and 64b in a position closer to a side of the rotational axis 69 in relation to the light attachment portion 63. The sidewall portion 64a extends on a left side of the light attachment portion 63. The sidewall portion 64b extends on a right side of the light attachment portion 63. The connection wall portion 64c connects the pair of sidewall portions 64a and 64b at a position more backward than the light attachment portion 63. The rib-side opening portion 64h is located between the pair of sidewall portions 64a and 64b in a position more frontward than the light attachment portion 63.

The storage box 40 includes a gas strut 84 herein. The gas strut 84 holds the cover 60 in the open state. Since the cover 60 is opened upward in the present embodiment, the cover 60 in the open state is moved toward the close state by self-weight when there is no gas strut 84. Since the gas strut 84 is included, the cover 60 can be held in the open state against the self-weight. The pair of gas struts 84 are provided on right and left sides. The gas strut 84 is a cylinder, for example. The cylinder includes a cylinder tube 85 and a cylinder rod 86, for example. One of the cylinder tube 85 and the cylinder rod 86 is connected to the box part 41, and the other one thereof is connected to the cover 60. Herein, the cylinder rod 86 is connected to the box part 41, and the cylinder tube 85 is connected to the cover 60. The box part 41 includes a gas strut connection part 48 connected to the gas strut 84. The gas strut connection part 48 protrudes inside from an edge on the front side of the opening portion 42 in the vehicle width direction. The cover 60 includes a gas strut connection part 66 connected to the gas strut 84. The gas strut connection part 66 is provided to the inner surface 61 of the cover 60.

Herein, the light attachment portion 63, the cover support portion opening 65h, and the gas strut connection part 66 are located in the same position in the front-back direction. The light attachment portion 63, the cover support portion opening 65h, and the gas strut connection part 66 are arranged side by side along the vehicle width direction. The pair of cover support portions 65 and the light attachment portion 63 are located between the pair of gas strut connection parts 66 in the vehicle width direction. The light attachment portion 63 is located between the pair of cover support portions 65 in the vehicle width direction.

The box part 41 and the cover 60 are sealed. Herein, a sealing edge 46 is formed the upper wall 45, and a sealing groove 67 is formed in the cover 60. The sealing edge 46 protrudes upward from an upper surface 51 of the upper wall 45. The sealing edge 46 is located outside the opening portion 42. The sealing edge 46 extends along the opening portion 42. Herein, the sealing edge 46 extends into a U-like shape. The sealing edge 46 includes a portion extending on the left side of the opening portion 42, a portion extending on the front side of the opening portion 42, and a portion extending on the right side of the opening portion 42. The portion extending on the front side of the opening portion 42 connects the portion extending on the left side of the opening portion 42 and the portion extending on the right side of the opening portion 42. The sealing groove 67 has a shape corresponding to the sealing edge 46. A seal lip S is housed in the sealing groove 67. The seal lip S extends over the whole sealing groove 67 along the sealing groove 67. The seal lip S is formed of an elastic material such as rubber or elastomer. When the seal lip S is compressed in the close state, a waterproof property between the box part 41 and the cover 60 is increased.

In the present embodiment, the bottom portion 43 of the storage box 40 occupies half or more of the mounting surface 31 of the cargo bed 30. The bottom portion 43 of the storage box 40 may occupy 70 percents or more, 80 percents or more, or 90 percents or more of the mounting surface 31 of the cargo bed 30.

The pair of rear pillar parts 20 of the ROPS are located on right and left sides in the rear portion of the vehicle 10. The rear pillar part 20 extends upward from the rear portion of the vehicle 10 toward the front side.

The pair of upper lateral portions 50 are located on the right and left sides. The pair of upper lateral portions 50 are larger than the mounting surface 31 of the cargo bed 30 in the vehicle width direction. A dimension from a left end of the upper lateral portion 50 on the left side to a right end of the upper lateral portion 50 on the right side is larger than that of the mounting surface 31 of the cargo bed 30 in the vehicle width direction.

The vehicle body 14 includes a pair of backward portions 36. The pair of backward portions 36 are located more backward than the pair of rear pillar parts 20. The pair of upper lateral portions 50 are disposed on the pair of backward portions 36. A part of the rear side cover 34 located in an inner rear part in the vehicle width direction serves as the backward portion 36 herein. The upper lateral portion 50 may cover the backward portion 36.

The upper lateral portion 50 extends outside a connection part between the lower part of the rear pillar part 20 and the vehicle body 14 in the vehicle width direction. In FIG. 6, a lower end 20a of the rear pillar part 20 constitutes the connection part with the vehicle body 14. An outer end of the upper lateral portion 50 in the vehicle width direction is located outside a lower end of the rear pillar part 20 in the vehicle width direction.

As illustrated in FIG. 5, the vehicle 10 includes a tail lamp 37. The tail lamp 37 is supported on the rear portion of the vehicle body 14. The tail lamp 37 is a lamp for making a person in back of the vehicle 10 recognize presence or an operation of the vehicle 10. The tail lamp 37 includes a brake lamp or a direction indicator, for example.

The upper lateral portion 50 extends outside an inner position of the tail lamp 37 in the vehicle width direction. Herein, the inner position of the tail lamp 37 in the vehicle width direction is located below the backward portion 36. Herein, the upper lateral portion 50 is located inside an outer position of the tail lamp 37 in the vehicle width direction. The upper lateral portion 50 may be located outside the outer position of the tail lamp 37 in the vehicle width direction.

The storage box 40 includes a locking part 80. The locking part 80 keeps the cover 60 in the close state. The locking part 80 includes a locking receiving part 81, a hook 82, and an operation part 83. The locking receiving part 81 is a part to which the hook 82 is hooked. The hook 82 can be moved between the locking position where the hook 82 is hooked to the locking receiving part 81 and an unlock position where the hook 82 is not hooked to the locking receiving part 81. The operation part 83 is a part receiving an operation of a user. The operation part 83 is continuously formed with the hook 82. The user can move the hook 82 by operating the operation part 83. Accordingly, the user can perform a locking operation and an unlocking operation on the locking part 80.

Herein, the locking receiving part 81 is provided to the box part 41, and the hook 82 and the operation part 83 are provided to the cover 60. For example, the locking receiving part 81 is a striker. The striker is located in back of the opening portion 42. The striker includes a U-like shaped part protruding outside the box part 41. The hook 82 is hooked to the U-like shaped part. The operation part 83 passes through the outer cover portion 60b of the back side portion 60d. A back end of the operation part 83 is located more backward than the back surface of the back side portion 60d. A front end of the operation part 83 is continuously formed with a base end of the hook 82 in an inner part of the cover 60 having the double structure. A slot is formed in a lower surface of the back side portion 60d. A distal end of the hook 82 gets in and out of the slot when the hook 82 is moved by the operation of the operation part 83. A back portion of the lower part of the back side portion 60d protrudes to a lower side than a part in which the slot is formed. The back portion of the lower part of the back side portion 60d can protect the locking part 80.

The storage box 40 includes a vehicle body attachment part 56. The vehicle body attachment part 56 is a part attaching the storage box 40 to the vehicle body 14. The storage box 40 is detachably attached to the vehicle body 14 by the vehicle body attachment part 56. An arrangement position of the vehicle body attachment part 56 is an optional position. A part operating the vehicle body attachment part 56 may be provided in the housing space of the box part 41. A part operating the vehicle body attachment part 56 may be provided outside the housing space of the box part 41.

According to the storage box 40 having the above configuration, the light L can be attached to the cover 60 by the light attachment portion 63.

The light attachment portion 63 includes the inclined surface 63a inclined to the side of the box part 41 as getting away from the rotational axis 69 with respect to the inner surface 61 of the cover 60. Since the light attachment portion 63 includes the inclined surface 63a, the light L attached to the light attachment portion 63 easily illuminates a back side of (herein, in front of) the housing space of the box part 41 while the cover 60 is opened.

The cover 60 includes the rib 64 located around the light attachment portion 63 in the inner surface 61 and protruding closer to the side of the box part 41 in relation to the light attachment portion 63. The rib 64 includes the rib-side opening portion 64h on the side where the rotational axis 69 is located. In this case, the rib 64 can block part of the light emitted in a direction other than that of the box part 41.

The rib-side opening portion 64h is located between the pair of sidewall parts 64a and 64b on the side closer to the rotational axis 69 in relation to the light attachment portion 63. Accordingly, the rib 64 can surround the light attachment portion 63 at the part other than the rib-side opening portion 64h.

The pair of upper lateral portions 50 in the storage box 40 are disposed on the vehicle body 14 at the position higher than the bottom portion 43 of the box part 41.

The upper lateral portion 50 is located on both sides of the inner surface 61 of the cover 60. Accordingly, the position of the upper lateral portion 50 can be raised.

The second opening region 42B has the larger dimension in the vehicle width direction than the first opening region 42A in the opening part 42 of the box part 41. The user has access to the inner part of the box part 41 from a side of the second opening region 42B in the opening portion 42. Since the second opening region 42B is larger than the first opening region 42A in the opening portion 42, it is easy to have access to the inner part of the box part 41.

The intermediate part of the box part 41 includes the large housing portion 47 having the larger area than the opening portion 42. Accordingly, a capacity of the storage box 40 can be increased.

The cover 60 is made up to be opened to the upper side from the close state. When the cover 60 is opened, the box part 41 is located on a lower side than the inner surface 61. Thus, the light L attached to the light attachment portion 63 easily illuminates the box part 41.

According to the vehicle 10, the light L can be attached to the cover 60 in the storage box 40 attached to the vehicle 10 such as a side-by-side vehicle having the ROPS.

The vehicle body 14 includes the backward portions 36 which are located more backward than the pair of rear pillars and the pair of upper lateral portions 50 are disposed on.

The upper lateral portion 50 extends outside the connection part between the lower portion of the rear pillar and the vehicle body 14 in the vehicle width direction. Since a length of the upper lateral portion 50 in the vehicle width direction can be increased, the storage box 40 can be firmly held on the vehicle body 14.

The vehicle 10 includes the tail lamp 37 supported on the rear portion of the vehicle body 14, and the upper lateral portion 50 extends outside the inner position of the tail lamp 37 in the vehicle width direction. Accordingly, the length of the upper lateral portion 50 in the vehicle width direction can be increased, and the storage box 40 can be firmly held on the vehicle body 14.

### Second Embodiment

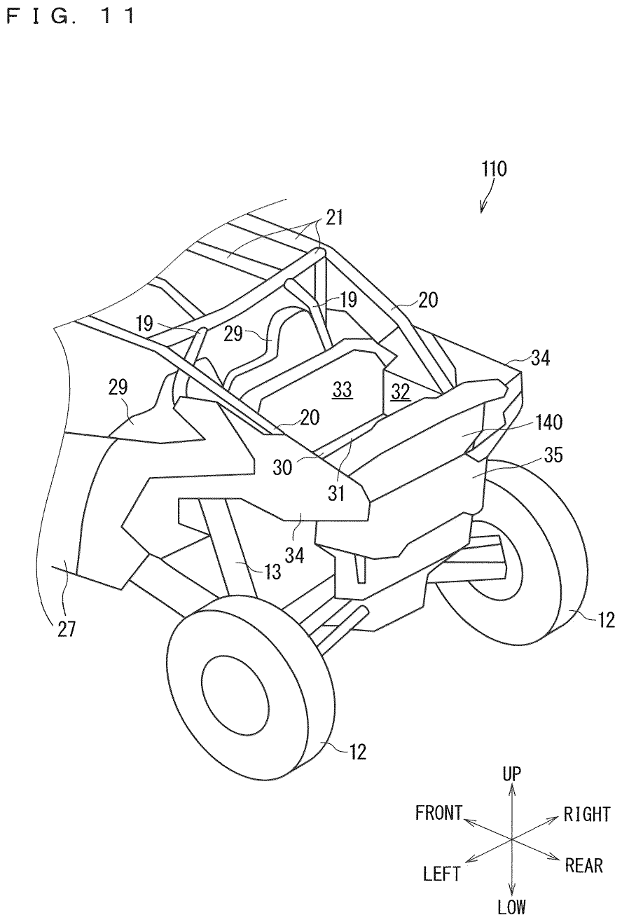

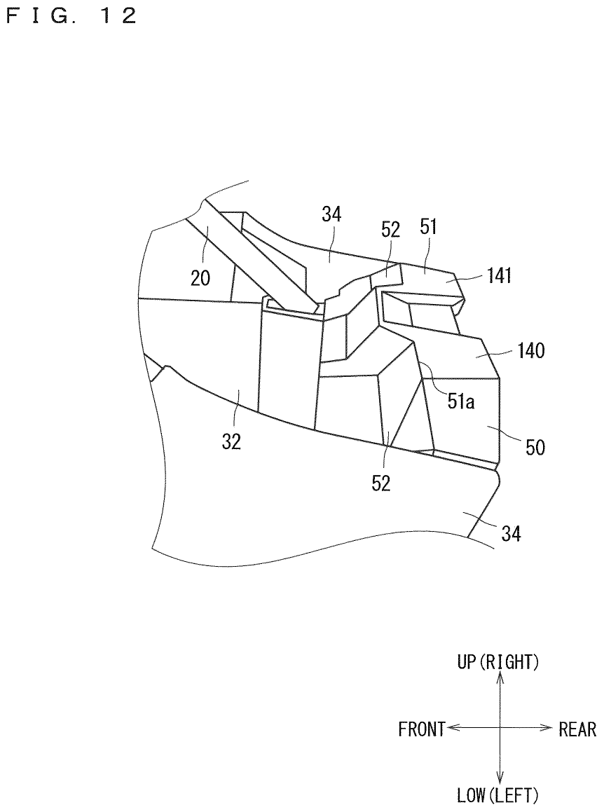

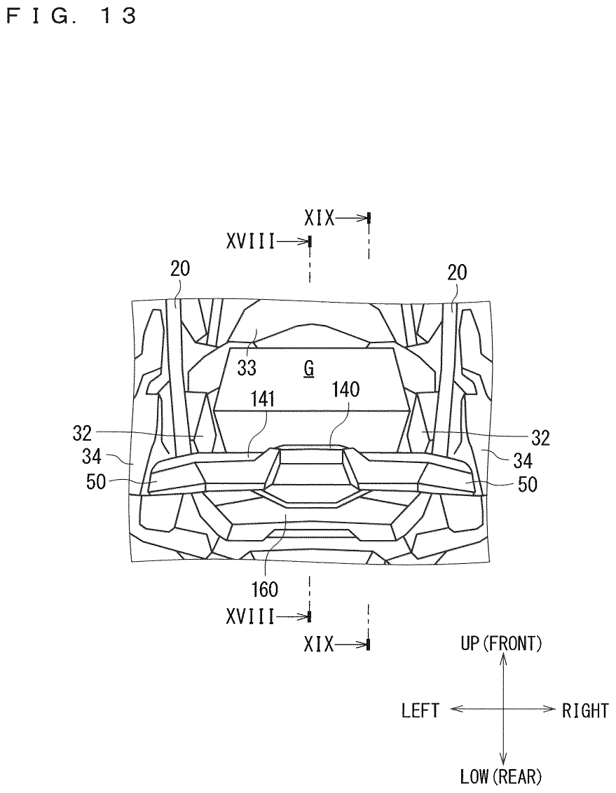

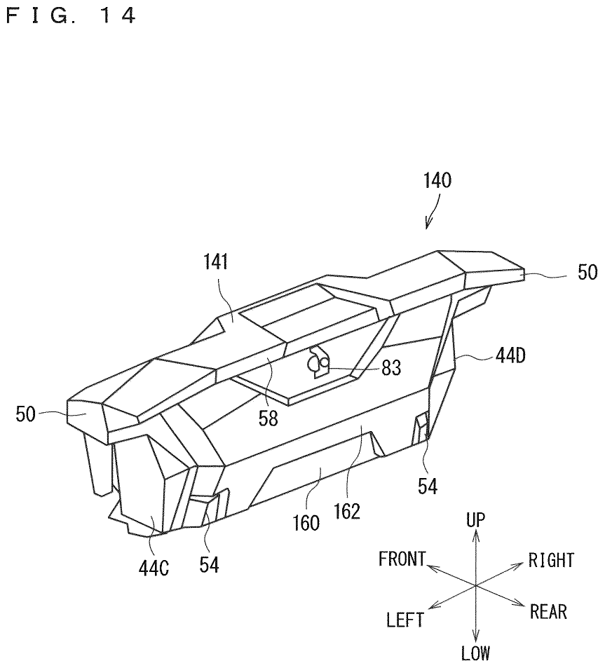

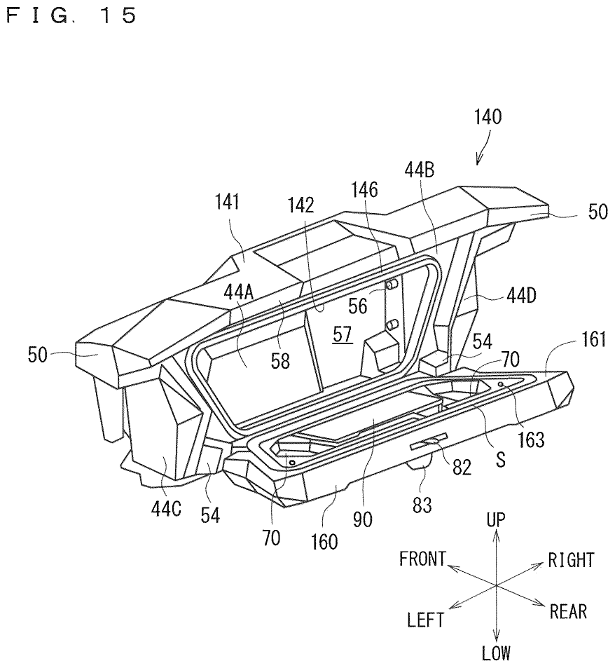

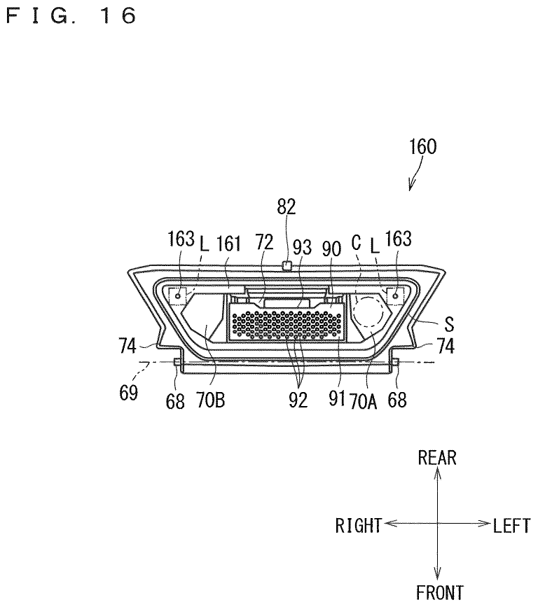

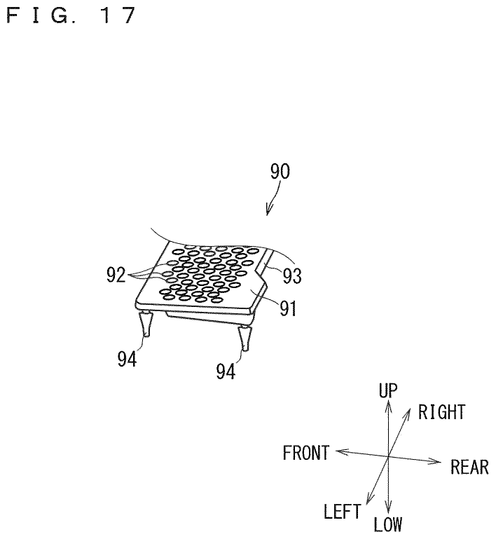

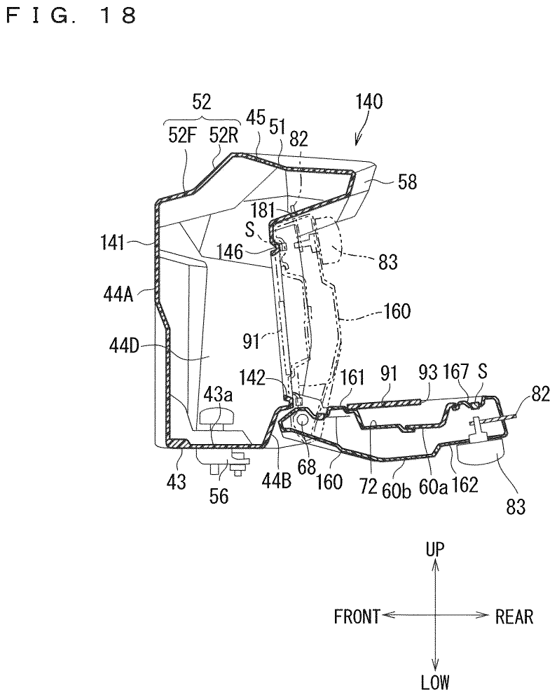

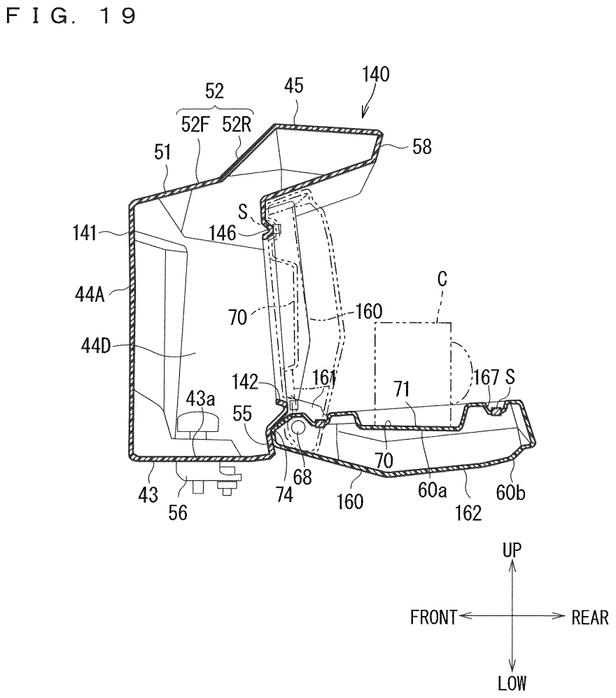

A storage box according to a second embodiment and a vehicle including the storage box will be hereinafter described. FIG. 11 is a perspective view illustrating a rear portion of a vehicle 110 according to the second embodiment. FIG. 12 and FIG. 13 are perspective views each illustrating the rear portion of the vehicle 110. FIG. 11, FIG. 12, and FIG. 13 are perspective views seen from viewpoints different from each other. FIG. 14 and FIG. 15 are perspective views each illustrating a storage box 140. FIG. 14 and FIG. 15 are perspective views seen from a similar viewpoint. FIG. 14 illustrates the storage box 140 in a closed state, and FIG. 15 illustrates the storage box 140 in an open state. FIG. 16 is a plan view illustrating a cover 160 of the storage box 140. FIG. 17 is a perspective view illustrating a storage net 90. FIG. 18 and FIG. 19 are cross-sectional views each illustrating the storage box 140. FIG. 18 corresponds to a cross section along an XVIII-XVIII line in FIG. 13, and FIG. 19 corresponds to a cross section along an XIX-XIX line in FIG. 13. In FIG. 18 and FIG. 19, the cover 160 in the open state is illustrated by a solid line, and the cover 160 in the close state is illustrated by a virtual line. In the description of the present embodiment, the same reference numerals are assigned to the similar constituent elements described above, and the description thereof will be omitted.

The storage box 140 is different from the storage box 40 described above in that the cover 160 is configured to be opened backward from the close state. The shaft portion 68 of the cover 160 is located below the cover 160. The shaft portion 68 is located on lower side and more backward than the opening portion 142. The rear wall 44B includes a pair of shaft bearing portions 54 protruding backward. A shaft bearing supporting the shaft portion 68 is provided to a surface of the shaft bearing portion 54 facing an inner side in the vehicle width direction. When the cover 160 is opened, an end part of the cover 160 (an upper end of the cover 160 in the close state) on a side opposite to the shaft portion 68 is moved backward and downward. An inner surface 161 of the cover 160 is directed frontward in the close state, and is directed upward in the open state. An outer surface 162 of the cover 160 is directed backward in the close state, and is directed downward in the open state.

The opening portion 142 is located in the rear wall 44B in the box part 141 of the storage box 140. A main housing space of the storage box 140 is located more frontward than the opening portion 142. The upper wall 45 is completely closed in the box part 141 of the storage box 140. The box part 141 includes a front side part 57 located more frontward than the opening portion 142 and a backward protruding portion 58 protruding backward from an upper part of the front side part 57. The backward protruding portion 58 covers above the upper end of the cover 160. In the close state, a major part of the cover 160 is located more frontward than the back end of the backward protruding portion 58. In the close state, the whole cover 160 is located more frontward than the back end of the backward protruding portion 58 herein. In the open state, the end part of the cover 160 (a backend of the cover 160 in the open state) on the side opposite to the shaft portion 68 is located more backward than the back end of the backward protruding portion 58.

The storage box 140 includes a storage net 90 attached to the cover 160. The storage net 90 is detachably attached to a center part of the inner surface 161. The storage net 90 appears in the open state. The user can use the storage net 90 in the open state. An upper surface of the storage net 90 is substantially horizontal in the open state.

The storage net 90 includes a net portion 91 and leg portions 94. The leg portions 94 protrude from the net portion 91. For example, the net portion 91 may be formed into a quadrangular shape in a plan view. The leg portions 94 may be provided to four corners of the net portion 91. A hole into which a distal end of the leg portion 94 is inserted may be formed in the cover 160. The leg portion 94 may be pressed into the hole in the cover 160 and held therein.

A concave portion 72 is formed in a part of the inner surface 161 of the cover 160 in which the storage net 90 is disposed. The concave portion 72 is a portion in which a part of the inner surface 161 is concaved toward the outer surface 162 more than the other part. A hole into which the leg portion 94 is inserted may be formed in an inner surface of the concave portion 72. The concave portion 72 may include a level difference. The level difference may be absorbed by changing a length of each of the leg parts 94.

Through holes 92 may be formed in the net portion 91. Each through hole 92 passes through an upper surface and a lower surface of the net portion 91. When a liquid such as a drink or a soup disposed on the cover 160 spills out over the upper surface of the net portion 91, the liquid is moved to a side of the lower surface through the through hole 92. The liquid passing through the through hole 92 can be received by the concave portion 72. Since the storage net 90 can be detached, the user can wipe the liquid received by the concave portion 72 or clean the concave portion 72.

An outer edge of the net portion 91 may include a concave edge portion 93. The concave edge portion 93 is a portion in which a part of the outer edge is concaved inward more than the other part thereof. Since the concave edge portion 93 is provided, the user can easily insert his/her hand between the cover 160 and the storage net 90 at a position of the concave edge portion 93 while the storage net 90 is attached to the cover 160. Accordingly, the storage net 90 can be easily detached from the cover 160. Herein, the concave edge portion 93 is located in a back edge of the net portion 91 in the open state. The concave edge portion 93 may be located in the other position.

The cover 160 includes a groove part 70 formed in the inner surface 161. The groove portion 70 is a portion in which a part of the inner surface 161 is concaved toward the outer surface 162 more than the other part. The groove portion 70 includes a first groove portion 70A located on one side of the storage net 90 and a second groove portion 70B located on the other side of the storage net 90 in the inner surface 161. Herein, the first groove portion 70A is located on a left side of the storage net 90, and the second groove portion 70B is located on a right side of the storage net 90. The groove portion 70 is a cup holder placing a cup C, for example. A bottom surface 71 of the groove portion 70 may be horizontal in the open state.

The box part 141 is disposed on the mounting surface 31 of the cargo bed 30 in the manner similar to the box part 41 of the storage box 40. A size of the box part 141 in the front-back direction is larger than that of the cargo bed 30 in the front-back direction. The storage box 140 is located in the rear portion of the cargo bed 30. The storage box 140 is not disposed in the front portion of the cargo bed 30. As illustrated in FIG. 13, a luggage G different from the storage box 140 can be disposed on the front portion of the cargo bed 30. The storage box 140 serves as a rear wall of the mounting surface 31 located in the front portion of the cargo bed 30. The storage box 140 functions as a tail gate for the cargo bed 30.

An upper surface 51 of the box part 141 includes an inclined surface 52 inclined downward as getting closer to the front side of the vehicle 10. Herein, the upper surface 51 of the upper wall 45 is the upper surface 51 of the box part 141. A portion of the upper surface 51 of the upper wall 45 is the inclined surface 52. A top portion 51a is located in an intermediate portion of the upper surface 51 of the upper wall 45 in the front-back direction herein. A part thereof more frontward than the top portion 51a is the inclined surface 52. A part thereof more backward than the top portion 51a is inclined downward as getting closer to the back side of the vehicle 10.

The user has access to the front portion of the cargo bed 30 over the storage box 140 from a position more backward than the storage box 140 in some cases. Since the inclined surface 52 is provided, the user can easily have access to the front portion of the cargo bed 30 over the storage box 140 from the position more backward than the storage box 140.

An inclination angle at the inclined surface 52 is changed in an intermediate portion along the front-back direction. An inclination angle of a back side inclined surface 52R located on the back side is larger than that of the front side inclined surface 52F located on the front side in the inclined surface 52. The inclined surface 52 includes the front side inclined surface 52F and the back side inclined surface 52R having the larger inclination angle than the front side inclined surface 52F. Accordingly, the upper surface 51 can be further lowered in height compared with a case where the inclined surface 52 of the upper surface 51 is evenly formed from the top part 51a. Accordingly, when the user has access to the front portion of the cargo bed 30 over the storage box 140 from the position more backward than the storage box 140, the user hardly interferes with the inclined surface 52.

The top portion 51a on the outer side in the vehicle width direction is located more backward than the top portion 51a on the inner side in the vehicle width direction in the upper surface 51. Accordingly, the user can easily pass over the top portion 51a on the outer side in the vehicle width direction.

The storage box 140 also includes the pair of upper lateral portions 50 in the manner similar to the storage box 40. The pair of upper lateral portions 50 are located on the right and left sides of the box part 141. The pair of upper lateral portions 50 are larger than the mounting surface 31 of the cargo bed 30 in the vehicle width direction. The pair of upper lateral portion 50 are located on both sides of the inner surface 161 of the cover 160 in the close state. The pair of upper lateral portions 50 are disposed on the vehicle body 14 at a position higher than the mounting surface 31 of the cargo bed 30. A relationship between the upper lateral portion 50 of the storage box 140 and the vehicle body 14 is similar to that between the upper lateral portion 50 of the storage box 40 and the vehicle body 14.

A sealing convex edge 146 is formed to go around the opening part 142 in the storage box 140. A sealing groove 167 and the seal lip S are formed to surround the groove portion 70 and the storage net 90 to correspond to the sealing convex edge 146.

A light attachment portion 163 is provided inside the seal lip S in the cover 160. A position of light attachment portion 163 is optionally set. For example, the light attachment portion 163 is provided between the seal lip S and the groove part 70. The light L can be attached to the light attachment portion 163 in the cover 160. The inclined surface 63a and the rib 64 are not provided in the light attachment portion 163. The inclined surface 63a and the rib 64 may be provided in the light attachment portion 163.

The striker as the locking receiving part 81 is not provided in the box part 141. A slit formed in a lower surface of the backward protruding portion 58 functions as a locking receiving portion 181 in place of the striker. When the distal end of the hook 82 gets in and out of the slit of the locking receiving portion 181, the locking part 80 is locked and unlocked.

The gas strut 84 is not provided in the storage box 140. The storage box 140 includes a catching portion 74 and a receiving portion 55 holding the cover 160 in a predetermined open state in place of the gas strut 84. The catching portion 74 is provided to the cover 160. The catching portion 74 is located in the lower portion of the cover 160 more frontward than the shaft portion 68. The receiving portion 55 is provided to the box part 141. The catching portion 74 and the receiving portion 55 are located away from each other in the close state. The catching portion 74 gets close to the receiving portion 55 as the state is changed from the close state to the open state. The catching portion 74 and the receiving portion 55 have contact with each other in the open state.

The catching portion 74 and the receiving portion 55 regulates rotation of the cover 160 by self-weight in the open state. Specifically, the cover 160 is opened backward, and a state where the storage net 90 is horizontal is the predetermined open state in the present embodiment. The self-weight of the cover 160 in this open state does not act as force of returning to the close state but acts as force of further opening the cover 160. The catching portion 74 is caught on the receiving portion 55 in the open state. Since the catching portion 74 and the receiving portion 55 have contact with each other in a rotational direction of the cover 160 in the open state, further rotation of the cover 160 can be regulated.

Also according to the storage box 140 having the above configuration and the vehicle 110 including the storage box 140, the light L can be attached to the cover 60 by the light attachment portion 63.

According to the storage box 140, the storage box 140 includes the storage net 90 attached to the cover 160, the cover 160 includes the inner surface 161 facing the side of the box part 141 in the close state and the groove portion 70 formed in the inner surface 161, and the cover 160 is opened backward from the close state. In this case, when the cover 160 is opened, the storage net 90 appears. The groove portion 70 of the inner surface 161 to which the storage net 90 is attached can be used as a cup holder, for example.

The storage net 90 is attached to the center portion of the inner surface 161, and the groove portion 70 includes the first groove portion 70A located on one side of the storage net 90 and the second groove portion 70B located on the other side of the storage net 90 in the inner surface 161. Accordingly, the cup C, for example, can be held on both sides of the storage net 90.

The upper surface 51 of the box part 141 includes the inclined surface 52 inclined downward as getting closer to the front side of the vehicle 10. Since the inclined surface 52 is located, the user can easily have access to the front portion of the cargo bed 30 over the storage box 140 partitioning the rear portion of the cargo bed 30.

The storage box 140 includes the pair of upper lateral portions 50 located on the right and left sides of the box part 141 and larger than the mounting surface 31 of the cargo bed 30 in the vehicle width direction, and the pair of upper lateral portions 50 are located on both sides of the inner surface 161 of the cover 160 in the close state to be disposed on the vehicle body 14 at the position higher than the mounting surface 31 of the cargo bed 30. Since the upper lateral portions 50 are located, the storage box 140 can be firmly held on the vehicle body 14. The position of the upper lateral portion 50 can be raised.

### Modification Example

The light attachment part 63 may be omitted in the storage box 140.

Configurations described in the above-mentioned embodiments and modification examples can be combined with each other as appropriate unless any contradiction occurs.

### Appendix

The present specification and the diagrams disclose each aspect described hereinafter.

A storage box according to a first aspect is a storage box attached to a cargo bed of a vehicle, including: a box part having an opening portion; and a cover supported on the box part to be angularly displaceable around a rotational axis and closing the opening part, wherein the cover includes an inner surface facing a side of the box part in a close state and a light attachment portion located in a part of the inner surface.

According to the first aspect, a light can be attached to the cover by the light attachment portion.

A second aspect is the storage box according to the first aspect, wherein the light attachment portion includes an inclined surface inclined to a side of the box part as getting away from the rotational axis with respect to the inner surface of the cover.

According to the second aspect, since the light attachment portions includes the inclined surface, the light attached to the light attachment portion easily illuminates the back side of the box part while the cover is opened.

A third aspect is the storage box according to the first or second aspect, wherein the cover includes a rib located around the light attachment portion in the inner surface and protruding to a side of the box part in relation to the light attachment portion, and the rib includes the rib-side opening portion on a side where the rotational axis is located.

According to the third aspect, the rib can block part of the light emitted in the direction other than that of the box part.

A fourth aspect is the storage box according to the third aspect, wherein the rib includes a pair of sidewall portions extending on both sides of the light attachment portion and a connection wall portion connecting the pair of sidewall portions at an opposite side of the rotational axis from the light attachment portion, and the rib-side opening portion is located between the pair of sidewall portions in a position closer to a side of the rotational axis in relation to the light attachment portion.

According to the fourth aspect, the rib can surround the light attachment portion at the part other than the rib-side opening portion.

A fifth aspect is the storage box according to any one of the first to fourth aspects, wherein the box part includes a bottom part disposed on a mounting surface of the cargo bed, the storage box further includes a pair of upper lateral parts located on right and left sides of the box parts and larger than the bottom surface of the box parts in a vehicle width direction, and the pair of upper lateral parts are disposed on a vehicle body at a position higher than the bottom surface of the box part.

According to the fifth aspect, since the upper lateral parts are located, the storage box can be firmly held on the vehicle body.

A sixth aspect is the storage box according to the fifth aspect, wherein the upper lateral parts are located on both sides of the inner surface of the cover.

According to the sixth aspect, the position of the upper lateral parts can be raised.

A seventh aspect is the storage box according to any one of the first to sixth aspects, wherein the opening portion of the box part includes a first opening region located on a side of the rotational axis and a second opening region located on a side opposite to the rotational axis, and the second opening region has a dimension in a vehicle width direction larger than the first opening region.

According to the seventh aspect, the user has access to an inner portion of the box part from the side of the second opening region in the opening portion. Since the second opening region is larger than the first opening region in the opening portion, it is easy to have access to the inner portion of the box part.

An eighth aspect is the storage box according to any one of the first to seventh aspects, wherein the box part includes a bottom surface and an intermediate portion located between the bottom surface and the opening portion, and the intermediate portion includes a large housing portion having an area larger than the opening portion in a case where the bottom surface is seen from above.

According to the eighth aspect, a capacity of the storage box can be increased.

A ninth aspect is the storage box according to any one of the first to eighth aspects, wherein the cover is opened upward from a close state, the box part includes a bottom portion, a front wall, a left wall and a right wall, the inner surface faces the bottom portion 43 in the close state, and the light attachment portion includes an inclined surface which is inclined to the bottom portion as getting away from the rotational axis with respect to the inner surface.

According to the ninth aspect, when the cover is opened, the box part is located on the lower side than the inner surface. Thus, the light attached to the light attachment part easily illuminates the box part.

A tenth aspect is the storage box according to any one of the first to eighth aspects, comprising a storage net attached to the inner surface of the cover, the rotational axis is located in a lower part of the box part with respect to the box part, the cover includes a groove portion in the inner surface, and the cover is opened backward from a close state.

According to the tenth aspect, when the cover is opened, the storage net appears. The groove portion of the inner surface to which the storage net is attached can be used as the cup holder, for example.

An eleventh aspect is the storage box according to the tenth aspect, wherein the storage net is attached to a center portion of the inner surface, and the groove portion includes a first groove portion located on one side of the storage net and a second groove portion located on another side of the storage net in the inner surface.

According to the eleventh aspect, the cup, for example, can be held on both sides of the storage net.

A vehicle according to a twelfth aspect includes: a vehicle body including a vehicle body frame having a rollover protective structure (ROPS) and a cargo bed; a seat located more frontward than the cargo bed and supported on the vehicle body; and a storage box attached to the cargo bed, wherein the storage box includes: a box part including an opening portion; and a cover supported on the box part to be angularly displaceable around a rotational axis and closing the opening portion, and the cover includes an inner surface facing a side of the box part in a close state and a light attachment portion located in a part of the inner surface.

According to the twelfth aspect, the light can be attached to the cover in the storage box attached to the vehicle such as the side-by-side vehicle having the ROPS.

A thirteenth aspect is the vehicle according to the twelfth aspect, wherein the vehicle body frame includes a pair of rear pillars located on right and left sides in a rear portion of a vehicle and extending upward, the cargo bed includes a mounting surface on which the storage box is disposed, the storage box includes a pair of upper lateral portions located on right and left sides and larger than the mounting surface of the cargo bed in a vehicle width direction, and the vehicle body includes a backward portion which is located more backward than the pair of rear pillars and the pair of upper lateral portions are disposed on.

According to the thirteenth aspect, since the upper lateral portions are disposed on the backward portion, the storage box can be firmly held on the vehicle body.

A fourteen aspect is the vehicle according to the thirteenth aspect, wherein the upper lateral portions extend to an outer side in a vehicle width direction than a connection part between a lower part of each of the rear pillars and the vehicle body.

According to the fourteenth aspect, since the length of the upper lateral portion in the vehicle width direction can be increased, the storage box can be firmly held on the vehicle body.

A fifteenth aspect is the vehicle according to any one of the twelfth to fourteenth aspect, including a tail lamp supported on a rear portion of the vehicle body, wherein the storage box includes a pair of upper lateral portions located on right and left sides and larger than the mounting surface of the cargo bed in a vehicle width direction, and the upper lateral portions extend to an outer side in a vehicle width direction than an inner position of the tail lamp in a vehicle width direction.

According to the fifteenth aspect, since the length of the upper lateral portion in the vehicle width direction can be increased, the storage box can be firmly held on the vehicle body.

A storage box according to a sixteenth aspect is a storage box attached to a rear portion of a cargo bed of a vehicle, including: a box part including an opening portion; a cover supported on the box part to be angularly displaceable around a rotational axis located in a lower portion of the box part and closing the opening portion; and a storage net attached to the cover, wherein the cover includes an inner surface facing a side of the box part in a close state and a groove portion in the inner surface, and the cover is opened backward from a close state.

According to the sixteenth aspect, when the cover is opened, the storage net appears. The groove portion of the inner surface to which the storage net is attached can be used as the cup holder, for example.

A seventeenth aspect is the storage box according to the sixteenth aspect, wherein the storage net is attached to a center portion of the inner surface, and the groove portion includes a first groove portion located on one side of the storage net and a second groove portion located on another side of the storage net.

According to the seventeenth aspect, the cup, for example, can be held on both sides of the storage net.

An eighteenth aspect is the storage box according to the sixteenth or seventeenth aspect, wherein an upper surface of the box part includes an inclined surface inclined downward as getting closer to a front side of a vehicle.

According to the eighteenth aspect, since the inclined surface is located, the user can easily have access to the front portion of the cargo bed over the storage box partitioning the rear portion of the cargo bed.

A nineteenth aspect is the storage box according to any one of the sixteenth to eighteenth aspects, wherein the box part is disposed on a mounting surface of the cargo bed, the vehicle further includes a pair of upper lateral portions located on right and left sides of the box part and larger than the mounting surface of the cargo bed in a vehicle width direction, and the pair of upper lateral portions are located on both sides of the inner surface of the cover while the cover is closed and disposed on a vehicle body at a position higher than the mounting surface of the cargo bed.

According to the nineteenth aspect, since the upper lateral portions are located, the storage box can be firmly held on the vehicle body. The position of the upper lateral portions can be raised.

The foregoing description is in all aspects illustrative and does not restrict the present invention. Numerous modifications and variations that have not yet been exemplified are devised without departing from the scope of the present invention.

1. A storage box attached to a cargo bed of a vehicle, comprising:
a box part having an opening portion; and
a cover supported on the box part to be angularly displaceable around a rotational axis and closing the opening portion, wherein
the cover includes an inner surface facing a side of the box part in a close state and a light attachment portion located in a part of the inner surface.

2. The storage box according to claim 1, wherein
the light attachment portion includes an inclined surface inclined to a side of the box part as getting away from the rotational axis with respect to the inner surface of the cover.

3. The storage box according to claim 1, wherein
the cover includes a rib located around the light attachment portion in the inner surface and protruding to a side of the box part in relation to the light attachment portion, and
the rib includes the rib-side opening portion on a side where the rotational axis is located.

4. The storage box according to claim 3, wherein
the rib includes a pair of sidewall portions extending on both sides of the light attachment portion and a connection wall portion connecting the pair of sidewall portions at an opposite side of the rotational axis from the light attachment portion, and
the rib-side opening portion is located between the pair of sidewall portions in a position closer to a side of the rotational axis in relation to the light attachment portion.

5. The storage box according to claim 1, wherein
the box part includes a bottom portion disposed on a mounting surface of the cargo bed, the storage box further includes
a pair of upper lateral portions located on right and left sides of the box parts and larger than the bottom surface of the box parts in a vehicle width direction, and
the pair of upper lateral portions are disposed on a vehicle body at a position higher than the bottom surface of the box part.

6. The storage box according to claim 5, wherein
the upper lateral portions are located on both sides of the inner surface of the cover.

7. The storage box according to claim 1, wherein
the opening portion of the box part includes a first opening region located on a side of the rotational axis and a second opening region located on a side opposite to the rotational axis, and
the second opening region has a dimension in a vehicle width direction larger than the first opening region.

8. The storage box according to claim 1, wherein
the box part includes a bottom surface and an intermediate portion located between the bottom surface and the opening portion, and
the intermediate portion includes a large housing portion having an area larger than the opening portion in a case where the bottom surface is seen from above.

9. The storage box according to claim 1, wherein
the cover is opened upward from a close state,
the box part includes a bottom portion, a front wall, a left wall and a right wall,
the inner surface faces the bottom portion in the close state, and
the light attachment portion includes an inclined surface which is inclined to the bottom portion as getting away from the rotational axis with respect to the inner surface.

10. The storage box according to claim 1, comprising
a storage net attached to the inner surface of the cover,
the rotational axis is located in a lower portion of the box part with respect to the box part,
the cover includes a groove portion in the inner surface, and
the cover is opened backward from a close state.

11. The storage box according to claim 10, wherein
the storage net is attached to a center portion of the inner surface, and
the groove portion includes a first groove portion located on one side of the storage net and a second groove portion located on another side of the storage net in the inner surface.

12. A vehicle, comprising:
a vehicle body including a vehicle body frame having a rollover protective structure (ROPS) and a cargo bed;
a seat located more frontward than the cargo bed and supported on the vehicle body; and
a storage box attached to the cargo bed, wherein
the storage box includes:
a box part including an opening portion; and
a cover supported on the box part to be angularly displaceable around a rotational axis and closing the opening portion, and
the cover includes an inner surface facing a side of the box part in a close state and a light attachment portion located in a part of the inner surface.

13. The vehicle according to claim 12, wherein
the vehicle body frame includes a pair of rear pillars located on right and left sides in a rear portion of a vehicle and extending upward,
the cargo bed includes a mounting surface on which the storage box is disposed,
the storage box includes a pair of upper lateral portions located on right and left sides and larger than the mounting surface of the cargo bed in a vehicle width direction, and
the vehicle body includes a backward portion which is located more backward than the pair of rear pillars and the pair of upper lateral portions are disposed on.

14. The vehicle according to claim 13, wherein
the upper lateral portions extend to an outer side in a vehicle width direction than connection part between a lower portion of each of the rear pillars and the vehicle body.

15. The vehicle according to claim 12, comprising
a tail lamp supported on a rear portion of the vehicle body, wherein
the storage box includes a pair of upper lateral portions located on right and left sides and larger than the mounting surface of the cargo bed in a vehicle width direction, and
the upper lateral portions extend to an outer side in a vehicle width direction than an inner position of the tail lamp in a vehicle width direction.

16. A storage box attached to a rear portion of a cargo bed of a vehicle, comprising:
a box part including an opening portion;
a cover supported on the box part to be angularly displaceable around a rotational axis located in a lower part of the box part and closing the opening portion; and
a storage net attached to the cover, wherein
the cover includes an inner surface facing a side of the box part in a close state and a groove portion in the inner surface, and
the cover is opened backward from a close state.

17. The storage box according to claim 16, wherein
the storage net is attached to a center portion of the inner surface, and
the groove portion includes a first groove portion located on one side of the storage net and a second groove portion located on another side of the storage net.

18. The storage box according to claim 16, wherein
an upper surface of the box part includes an inclined surface inclined downward a getting closer to a front side of a vehicle.

19. The storage box according to claim 16, wherein
the box part is disposed on a mounting surface of the cargo bed,
the storage box further includes a pair of upper lateral portions located on right and left sides of the box part and larger than the mounting surface of the cargo bed in a vehicle width direction, and
the pair of upper lateral portions are located on both sides of the inner surface of the cover while the cover is closed and disposed on a vehicle body at a position higher than the mounting surface of the cargo bed.
